(19) United States
(12) Patent Application Publication
(10) Pub. No.: US 2026/0211282 A1
(43) Pub. Date: Jul. 23, 2026

(54) AUTOMOTIVE DISPLAY AND BACKLIGHT MODULE THEREOF

(71) Applicant: AmTRAN Technology Co., Ltd., New Taipei City (TW)

(72) Inventors: Chih Kuei WANG, New Taipei City (TW); Min Hung CHENG, Taipei City (TW); Yi Zhong CHIU, New Taipei City (TW)

(21) Appl. No.: 19/452,384

(22) Filed: Jan. 18, 2026

(30) Foreign Application Priority Data
Jan. 20, 2025 (TW) 114102373

(51) Int. Cl. G02F 1/13357

(52) U.S. Cl. CPC G02F 1/133608; G02F 1/133606

(57) ABSTRACT

A backlight module includes a housing, a diffuser, a light source and a flexible positioning member. The housing includes a backplate and a sidewall having an opening. The diffuser is disposed in the housing and includes a main body and a protruding portion. The protruding portion is disposed on a periphery of the main body and corresponds to the opening of the sidewall. The light source is disposed in the housing. The flexible positioning member is sleeved onto the protruding portion of the diffuser and has a slot mating with an inner edge of the opening of the sidewall.

### RELATED APPLICATIONS

This application claims priority to Taiwan Application Serial Number 114102373, filed January 20, 2025, the disclosure of which is incorporated herein by reference in its entirety.

### BACKGROUND

### Technical Field

The present disclosure relates to an automotive display and a backlight module thereof.

### Description of Related Art

With the widespread adoption of automotive displays in modern vehicles, their applications have covered functions such as navigation systems, entertainment systems, and vehicle information displays. However, when a vehicle is moving, automotive display often experiences various forms of vibrations due to uneven road surfaces or external disturbances. These vibrations not only affect the stability of displaying content, but may also cause abnormal noises created by the internal structures of the display, thereby negatively affecting the user's driving experience. In view of said problem, various technical solutions have been proposed in the industry to reduce the impact of vibrations on automotive displays.

Some of the previously proposed solutions focused on improving the structures of the display housing. For example, certain solutions adopt more rigid housing materials in hope of reducing the impacts of vibrations by improving the overall stiffness. Although such designs can help reduce, to a certain extent, the amplitude of vibrations transmitted to the interior of the display, vibrations can still cause frictions or collisions among the optical components of the backlight module due to gaps or assembly tolerances exist among the optical components, thereby generating abnormal noises. Such abnormal noises not only affect the quietness within the vehicle, but may also indicate long-term wear of the optical components, which may result in shortened service life of the display.

### SUMMARY

In view of the foregoing, one of the objects of the present disclosure is to provide an automotive display and a backlight module with high reliability.

In accordance with an embodiment of the present disclosure, a backlight module includes a housing, a diffuser, a light source and a flexible positioning member. The housing includes a backplate and a sidewall having an opening. The diffuser is disposed in the housing and includes a main body and a protruding portion. The protruding portion is disposed on a periphery of the main body and corresponds to the opening of the sidewall. The light source is disposed in the housing. The flexible positioning member is sleeved onto the protruding portion of the diffuser and has a slot mating with an inner edge of the opening of the sidewall.

In one or more embodiments of the present disclosure, the flexible positioning member surrounds the protruding portion of the diffuser and has a hole. The protruding portion is inserted into the hole.

In one or more embodiments of the present disclosure, the hole is perforated through the flexible positioning member.

In one or more embodiments of the present disclosure, the sidewall further has an indented portion. The indented portion is indented inward from an outer surface of the sidewall. The opening is formed on the indented portion.

In one or more embodiments of the present disclosure, the outer surface of the sidewall defines a reference plane. The opening of the sidewall and the flexible positioning member are located inside the reference plane.

In one or more embodiments of the present disclosure, the sidewall has a leading edge. The inner edge of the opening includes a first section. The first section is connected to the leading edge of the sidewall and is substantially perpendicular to the leading edge of the sidewall. The slot of the flexible positioning member mates with the first section.

In one or more embodiments of the present disclosure, the sidewall has a leading edge. The inner edge of the opening includes a second section. The second section is located between the leading edge of the sidewall and the backplate and is substantially parallel to the leading edge of the sidewall. The slot of the flexible positioning member mates with the second section.

In one or more embodiments of the present disclosure, the light source is disposed on the backplate. The backlight module further includes a supporting member. The supporting member is disposed on an inner side of the flexible positioning member and abuts the light source, the sidewall and the diffuser.

In one or more embodiments of the present disclosure, the supporting member has a supporting surface abutting the diffuser. The flexible positioning member has a hole, and the protruding portion of the diffuser is inserted into the hole. A portion of an inner surface of the hole is aligned with the supporting surface of the supporting member.

In one or more embodiments of the present disclosure, the backlight module further includes a frame. The housing has an accommodating space. The frame extends to a side of the sidewall and the flexible positioning member away from the accommodating space. The frame abuts an edge of the sidewall away from the backplate and an edge of the flexible positioning member away from the backplate.

In accordance with an embodiment of the present disclosure, an automotive display includes a display panel and the backlight module described above. The backlight module faces a rear surface of the display panel.

In summary, the backlight module of the present disclosure includes a housing, a diffuser and a flexible positioning member. The flexible positioning member is sleeved onto a protruding portion on an edge of the diffuser and mates with an opening on a sidewall of the housing. By this arrangement, the diffuser can be firmly secured to prevent displacement of the diffuser when the backlight module is shaken, and thus prevent the diffuser from colliding with other components and producing abnormal noises. Furthermore, the flexible positioning member is compression resistant and does not easily fail in a high temperature environment where various components of the backlight module expand. Hence, the backlight module of the present disclosure is highly reliable and is suitable to be applied in environments with large temperature variations and frequent vibrations, such as on vehicles.

### BRIEF DESCRIPTION OF THE DRAWINGS

To make the objectives, features, advantages, and embodiments of the present disclosure, including those mentioned above and others, more comprehensible, descriptions of the accompanying drawings are provided as follows.

FIG. 1 illustrates an isometric view of a display device in accordance with an embodiment of the present disclosure;

FIG. 2 illustrates an exploded view of the backlight module of the display device shown in FIG. 1;

FIG. 3 illustrates a cross-sectional view of the display device shown in FIG. 1 taken along the line segment 3-3’; and

FIGS. 4-6 illustrate enlarged views of some components of the backlight module shown in FIG. 2.

### DETAILED DESCRIPTION

For the completeness of the description of the present disclosure, reference is made to the accompanying drawings and the various embodiments described below. Various features in the drawings are not drawn to scale and are provided for illustration purposes only. To provide full understanding of the present disclosure, various practical details will be explained in the following descriptions. However, a person with an ordinary skill in relevant art should realize that the present disclosure can be implemented without one or more of the practical details. Therefore, the present disclosure is not to be limited by these details.

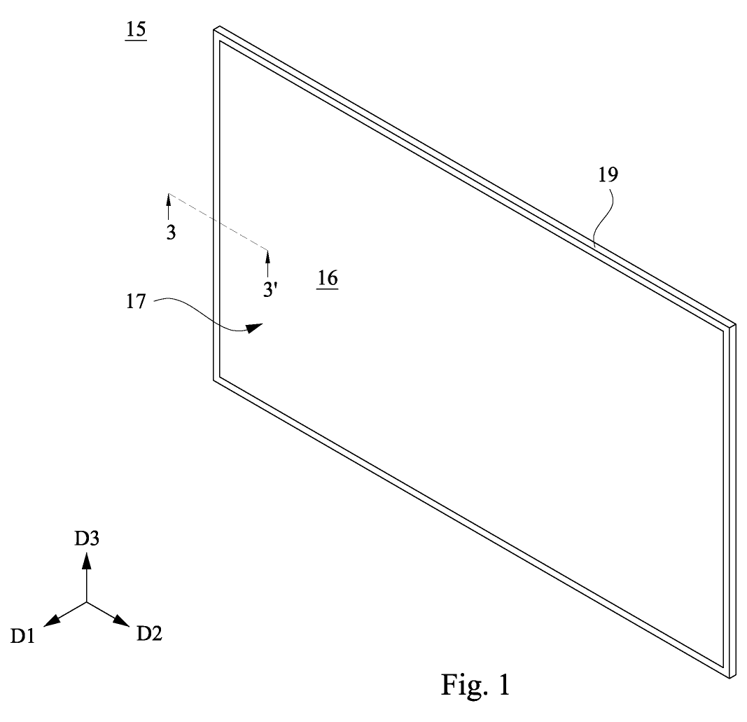

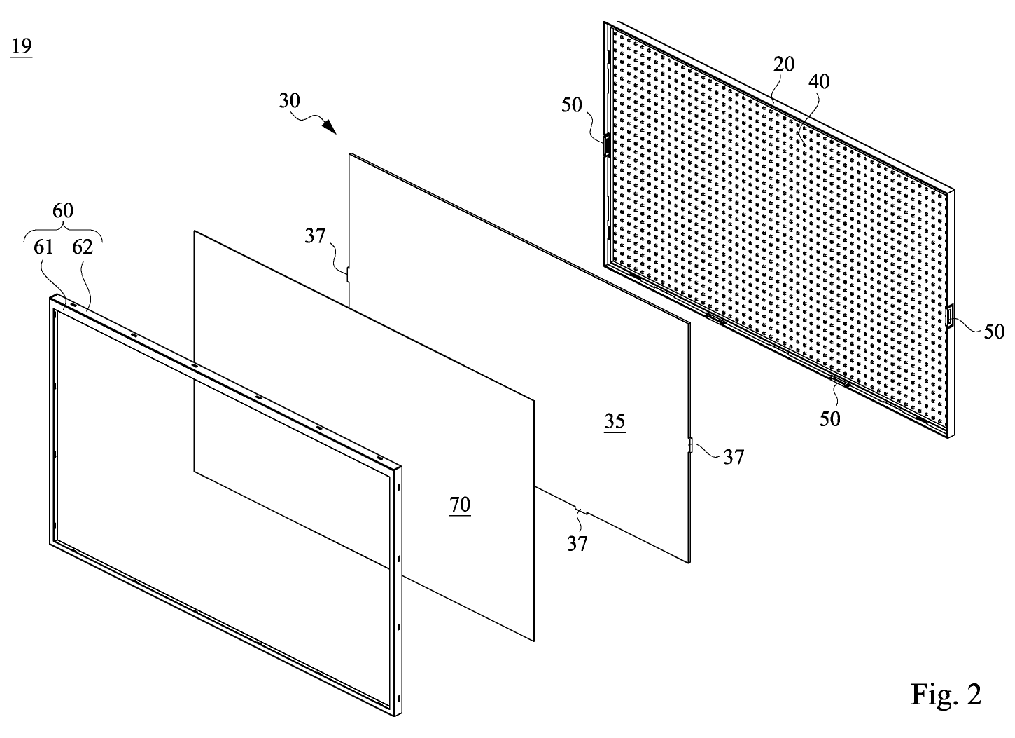

Reference is made to FIG. 1. FIG. 1 illustrates an isometric view of a display device 15 in accordance with an embodiment of the present disclosure. The display device 15 includes a display panel 16 (e.g., an LCD panel) and a backlight module 19. The display panel 16 has a first surface 17 and an opposite second surface 18 (see FIG. 2). The first surface 17 faces outwardly to display a screen. In other words, the first surface 17 is the display surface of the display panel 16. The second surface 18 is the rear surface of the display panel 16. The backlight module 19 is disposed facing the second surface 18 of the display panel 16. The backlight module 19 is configured to provide light to illuminate the display panel 16 for displaying a screen. The display device 15 of the present disclosure can be an automotive display, but is not limited thereto.

As shown in FIG. 1, the first surface 17 of the display panel 16 faces a first direction D1. In other words, the first direction D1 is a normal direction of the first surface 17 of the display panel 16. The display device 15 further has two edges extending along a second direction D2 and two other edges extending along a third direction D3. In some embodiments, the first direction D1, the second direction D2 and the third direction D3 are mutually orthogonal.

It should be noted that the first direction D1, the second direction D2 and the third direction D3 define a coordinate system associated with the display device 15 and the backlight module 19. Hence, when the orientation of the display device 15 and the backlight module 19 changes (e.g., to a laid-down position shown in FIG. 2), the coordinate system would rotate correspondingly.

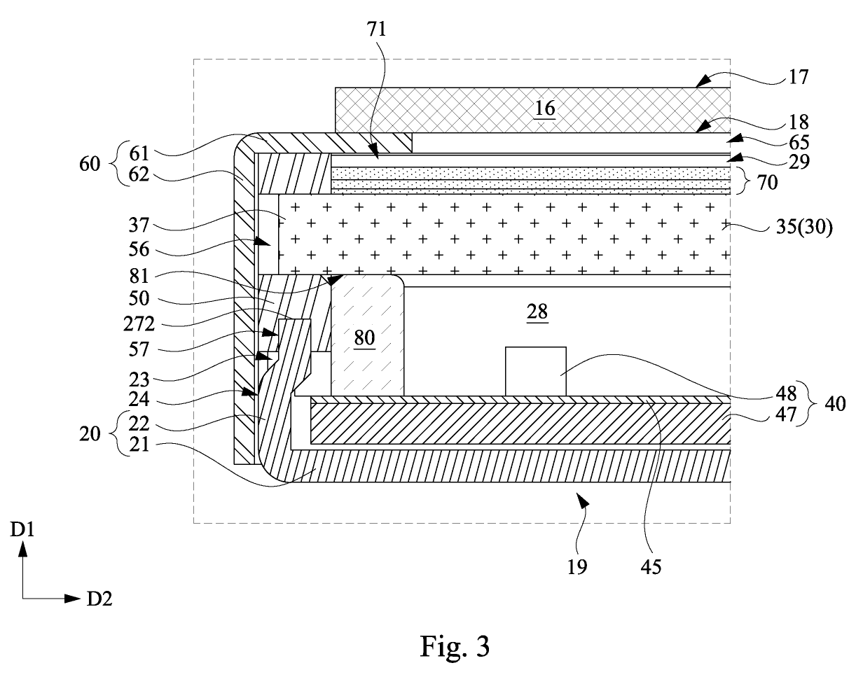

Reference is made to FIGS. 2 and 3. FIG. 2 illustrates an exploded view of the backlight module 19 of the display device 15 shown in FIGS. 1, and 3 illustrates a cross-sectional view of the display device 15 shown in FIG. 1 taken along the line segment 3-3’. As shown, the backlight module 19 includes a housing 20, a diffuser 30 and a light source 40. The housing 20 has an accommodating space 28 and a light exit opening 29 communicating with the accommodating space 28. The display panel 16 is disposed facing the light exit opening 29 of the housing 20. The diffuser 30 and the light source 40 are disposed in the accommodating space 28 of the housing 20, and the light source 40 faces the diffuser 30. The light source 40 is configured to emit light, such that the emitted light passes through the diffuser 30, subsequently travels to the outside of the housing 20 via the light exit opening 29, and eventually illuminates the display panel 16.

As shown in FIGS. 2 and 3, the light source 40 can include at least one light board or light bar. The light board or light bar can include a circuit board 47 and a plurality of light emitting elements 48 disposed on the circuit board 47. The light emitting elements 48 may include one or more LEDs or mini-LEDs. The backlight module 19 can further include a reflector sheet 45 covering the circuit board 47 of the light source 40. The reflector sheet 45 can include a plurality of openings (not depicted in the drawings). The light emitting elements 48 are exposed in the openings of the reflector sheet 45.

As shown in FIGS. 2 and 3, the housing 20 includes a backplate 21 and a sidewall 22. The backplate 21 is opposite to the light exit opening 29. The sidewall 22 is connected to the backplate 21 and bent relative to the backplate 21. In the illustrated embodiment, the light source 40 is disposed on the backplate 21 and faces the light exit opening 29 of the housing 20 (i.e., the facing direction of the light source 40 is the first direction D1). The diffuser 30 is located between the light source 40 and the light exit opening 29 of the housing 20. Hence, in the illustrated embodiment, the backlight module 19 is a direct-lit backlight module.

As shown in FIGS. 2 and 3, the diffuser 30 includes a main body 35 and at least one protruding portion 37. The main body 35 is substantially rectangular and faces the light source 40. The protruding portion 37 is connected to the main body 35 and is disposed on a periphery of the main body 35. The main body 35 has a third surface facing the light source 40, a fourth surface opposite to the third surface, and a fifth surface connected between the third surface and the fourth surface. The protruding portion 37 protrudes from the fifth surface of the main body 35. The backlight module 19 further includes at least one flexible positioning member 50 disposed on the sidewall 22 of the housing 20. The flexible positioning member 50 encases the protruding portion 37 of the diffuser 30, thereby fixing the diffuser 30. The flexible positioning member 50 can include elastic material, such as rubber. The flexible positioning member 50 can be inserted into an opening on the sidewall 22 of the housing 20. More details will be provided below.

As shown in FIGS. 2 and 3, the sidewall 22 is formed by one or more connected wall portions. In the illustrated embodiment, the sidewall 22 includes four wall portions, which surround the backplate 21 on four sides. In some embodiments, the backlight module 19 can include a plurality of flexible positioning members 50 disposed on at least two wall portions of the sidewall 22. Correspondingly, the diffuser 30 can include a plurality of protruding portions 37. The protruding portions 37 are disposed on at least two edges of the diffuser 30, and each protruding portion 37 is coupled to a corresponding flexible positioning member 50. In some embodiments, a wall portion of the sidewall 22 can be provided with multiple flexible positioning members 50. Correspondingly, one edge of the diffuser 30 can have multiple protruding portions 37 formed thereon. Each protruding portion 37 is coupled to a corresponding flexible positioning member 50.

As shown in FIGS. 2 and 3, in some embodiments, the backlight module 19 further includes at least one optical film 70. The optical film 70 is disposed on a side of the diffuser 30 away from the light source 40. In other words, the diffuser 30 is disposed between the light source 40 and the optical film 70. The light source 40, the diffuser 30 and the optical film 70 are arranged along the first direction D1. The optical film 70 may include at least one of a diffuser film, a prism film, a brightness enhancement film, or optical films having other functions. In some embodiments, the backlight module 19 includes a plurality of optical films 70 stacked with the diffuser 30. In some embodiments, the optical film 70 and the diffuser 30 can be fixedly combined using an adhesive. In some embodiments, multiple optical films 70 can be fixedly combined using an adhesive.

As shown in FIGS. 2 and 3, in some embodiments, the backlight module 19 further includes a frame 60. The frame 60 is disposed on the housing 20 and is configured to support the display panel 16. The frame 60 can have a light exit opening 65 to allow the light emitted by the light source 40 to illuminate the display panel 16. In some embodiments, the frame 60 includes a first portion 61 and a second portion 62 connected to the first portion 61. The first portion 61 covers peripheral regions of the optical film 70 and the diffuser 30. The display panel 16 is disposed on the first portion 61 of the frame 60. Moreover, the first portion 61 of the frame 60 can abut the edges of the sidewall 22 and the flexible positioning member 50 away from the backplate 21 to prevent detachment of the flexible positioning member 50 from the sidewall 22. The second portion 62 of the frame 60 is bent relative to the first portion 61 and extends to an outer side of the sidewall 22 of the housing 20 and the flexible positioning member 50 (i.e., the side of the sidewall 22 and the flexible positioning member 50 away from the accommodating space 28). The second portion 62 of the frame 60 can be fixed to the sidewall 22 of the housing 20 by snap-fit engagement, adhesive bonding or other suitable means. In some embodiments, the first portion 61 of the frame 60 is substantially perpendicular to the second portion 62.

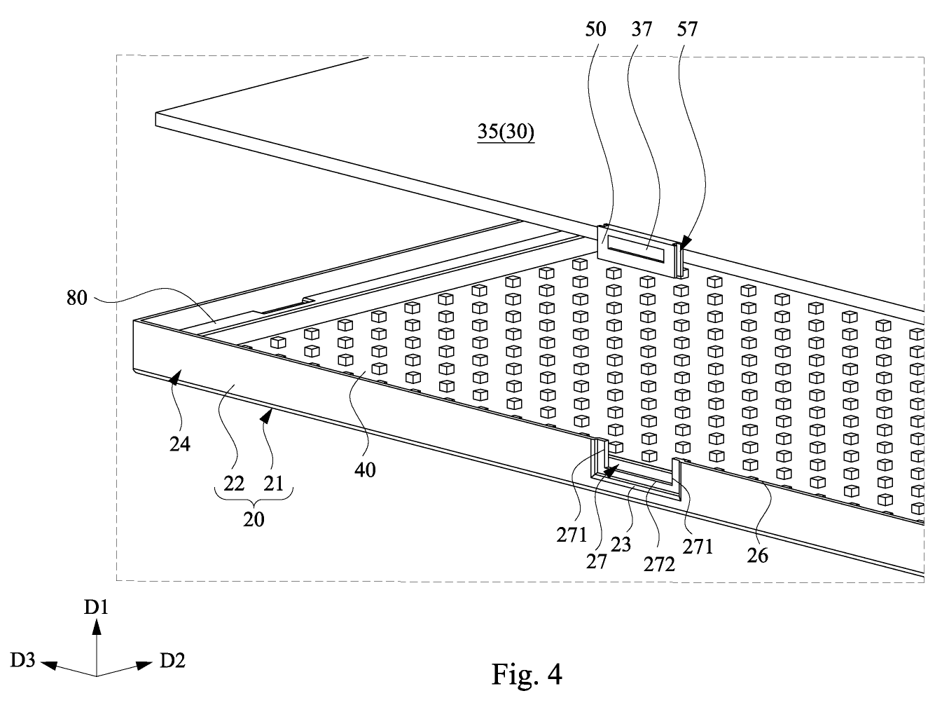

Reference is made additionally to FIG. 4. FIG. 4 illustrates an enlarged view of some components of the backlight module 19 shown in FIG. 2. As shown in FIGS. 3 and 4, the sidewall 22 of the housing 20 has at least one opening 27. The protruding portion 37 of the diffuser 30 corresponds to the opening 27 of the sidewall 22. The flexible positioning member 50 is sleeved onto the protruding portion 37 of the diffuser 30 and mates with the opening 27 of the sidewall 22. Specifically, the flexible positioning member 50 has a slot 57. The slot 57 is arranged along a periphery of the flexible positioning member 50 and mates with an inner edge of the opening 27 of the sidewall 22. In other words, at least part of the inner edge of the opening 27 of the sidewall 22 is inserted into the slot 57 of the flexible positioning member 50. In other words, at least part of the inner edge of the opening 27 of the sidewall 22 is clamped by the flexible positioning member 50.

As shown in FIGS. 3 and 4, in some embodiments, the flexible positioning member 50 is a closed annular structure. The flexible positioning member 50 surrounds the protruding portion 37 of the diffuser 30 and has a hole 56. The protruding portion 37 is inserted into the hole 56. In some embodiments, the hole 56 is perforated through the flexible positioning member 50 to facilitate assembly of the backlight module. Specifically, the hole 56 can extend from a surface of the flexible positioning member 50 facing the accommodating space 28 to another surface of the flexible positioning member 50 away from the accommodating space 28. In other words, the hole 56 is a through hole.

In some embodiments, a size of the hole 56 of the flexible positioning member 50 is slightly smaller than a size of the protruding portion 37 of the diffuser 30. As a result, when the protruding portion 37 of the diffuser 30 is inserted into the hole 56 of the flexible positioning member 50, the flexible positioning member 50 can be tightly coupled with the protruding portion 37 of the diffuser 30. In some embodiments, in a direction parallel to an edge of the diffuser 30, a width of the protruding portion 37 is at least 10 mm to prevent the protruding portion 37 from rupturing. Correspondingly, a width of the hole 56 of the flexible positioning member 50 is at least 10 mm.

As shown in FIGS. 3 and 4, the sidewall 22 has a leading edge 26, which is the edge of the sidewall 22 away from the backplate 21. In some embodiments, the opening 27 on the sidewall 22 is recessed from the leading edge 26 of the sidewall 22 towards the backplate 21. In other words, the opening 27 is a notch on the leading edge 26 of the sidewall 22. In some embodiments, the inner edge of the opening 27 on the sidewall 22 includes at least one first section 271. The first section 271 is connected to the leading edge 26 of the sidewall 22 and is substantially perpendicular to the leading edge 26 of the sidewall 22. The slot 57 is disposed on at least one edge of the flexible positioning member 50 facing the at least one first section 271 and mates with the first section 271.

As shown in FIGS. 3 and 4, in some embodiments, the inner edge of the opening 27 on the sidewall 22 includes a second section 272. The second section 272 is located between the leading edge 26 of the sidewall 22 and the backplate 21 and is substantially parallel to the leading edge 26 of the sidewall 22. The slot 57 is also disposed on an edge of the flexible positioning member 50 facing the second section 272 and mates with the second section 272.

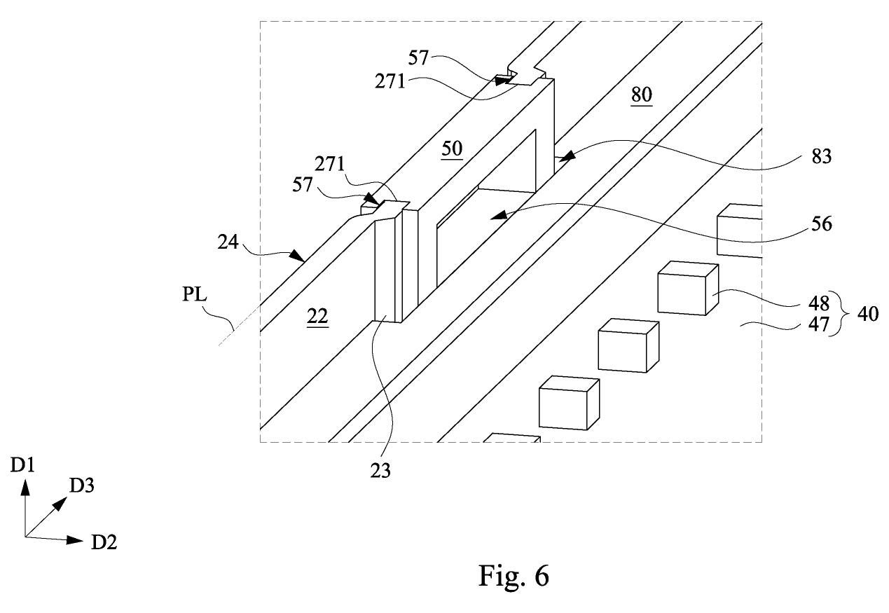

As shown in FIGS. 3 and 4, in some embodiments, a portion of the flexible positioning member 50 is located on a side of the diffuser 30 away from the light source 40. A retaining slot 71 is formed among the first portion 61 of the frame 60, the flexible positioning member 50 and the diffuser 30. The peripheral region of the optical film 70 is disposed in the retaining slot 71. In some embodiments, the flexible positioning member 50 protrudes relative to an inner surface of the sidewall 22 (also see FIG. 6), such that the optical film 70 can be prevented from colliding with the sidewall 22 when being displaced.

As shown in FIGS. 3 and 4, in some embodiments, the backlight module 19 further includes a supporting member 80. The supporting member 80 is disposed on an inner side of the flexible positioning member 50 and abuts the light source 40, the sidewall 22 and the diffuser 30. In some embodiments, the supporting member 80 has a supporting surface 81. The supporting surface 81 abuts the third surface, which faces the light source 40, of the diffuser 30. A portion of an inner surface of the hole 56 of the flexible positioning member 50 is aligned with the supporting surface 81 of the supporting member 80. For example, a portion of the inner surface of the hole 56 that is close to the backplate 21 can be aligned with the supporting surface 81 of the supporting member 80. By this arrangement, the flexible positioning member 50 and the supporting member 80 can jointly and stably support the diffuser 30. In some embodiments, in the first direction D1, a minimum distance from the hole 56 of the flexible positioning member 50 to the backplate 21 is substantially equal to a distance from the supporting surface 81 of the supporting member 80 to the backplate 21.

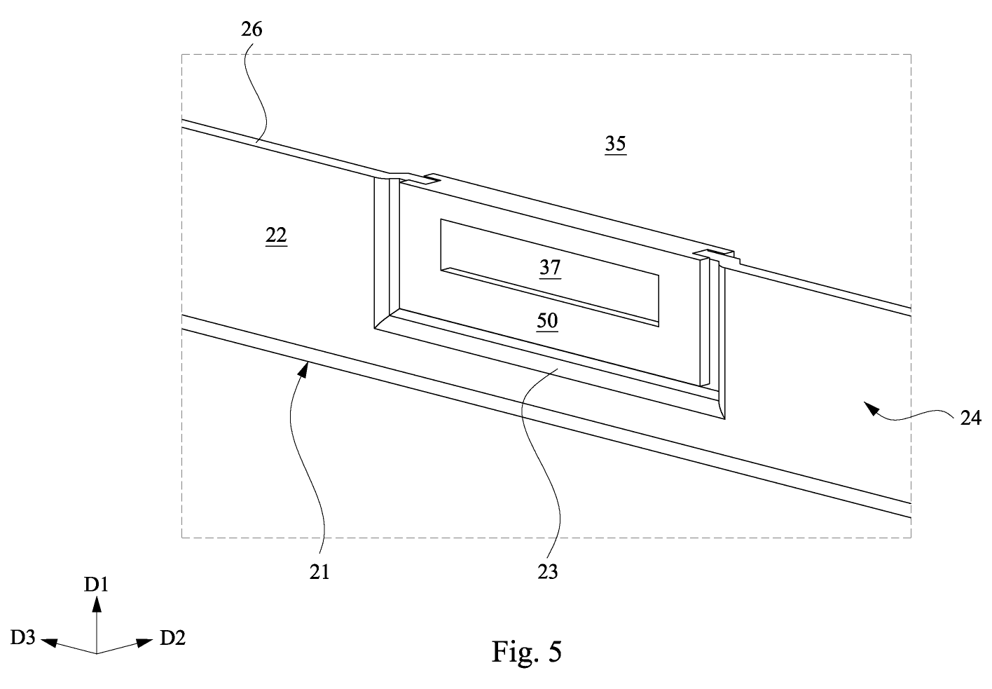

As shown in FIGS. 3 and 4, in some embodiments, when the flexible positioning member 50 is assembled onto the sidewall 22, the leading edge 26 of the sidewall 22 is substantially aligned with a surface of the flexible positioning member 50 away from the backplate 21 (also see FIG. 5), such that the frame 60 can be stably rest against the sidewall 22. A distance from the leading edge 26 of the sidewall 22 to the backplate 21 defines a height of an optical cavity of the backlight module 19. In the first direction D1, a height of the flexible positioning member 50 is less than the height of the optical cavity, and a height of a portion of the sidewall 22 corresponding to the opening 27 is at least 2.5 mm to facilitate assembly of the backlight module.

Reference is made additionally to FIGS. 5 and 6. FIGS. 5 and 6 illustrate enlarged views of some components of the backlight module 19 shown in FIG. 2. As shown in FIGS. 4 to 6, the sidewall 22 has an outer surface 24, which is the surface of the sidewall 22 away from the accommodating space 28. In some embodiments, the sidewall 22 further has an indented portion 23. The indented portion 23 is indented inward from the outer surface 24 of the sidewall 22. The opening 27 of the sidewall 22 is formed on the indented portion 23. In some embodiments, the outer surface 24 of the sidewall 22 defines a reference plane PL. The opening 27 of the sidewall 22 and the flexible positioning member 50 are located inside the reference plane PL and do not cross the reference plane PL. By this arrangement, providing the flexible positioning member 50 on the sidewall 22 of the housing 20 does not cause the overall width of the housing 20 to increase. In other words, the flexible positioning member 50 does not protrude relative to the outer surface 24 of the sidewall 22. As a result, the frame 60 can stably rest against the outer surface 24 of the sidewall 22. In some embodiments, an outer surface of the flexible positioning member 50 (i.e., the surface of the flexible positioning member 50 away from the accommodating space 28) is substantially aligned with the outer surface 24 of the sidewall 22.

As shown in FIGS. 4 to 6, in some embodiments, the supporting member 80 extends continuously along the sidewall 22. In some embodiments, the supporting member 80 further has at least one recess 83, which is positioned corresponding to the indented portion 23 of the sidewall 22 and the flexible positioning member 50. The indented portion 23 of the sidewall 22 and the flexible positioning member 50 are received by the recess 83 of the supporting member 80.

In summary, the backlight module of the present disclosure includes a housing, a diffuser and a flexible positioning member. The flexible positioning member is sleeved onto a protruding portion on an edge of the diffuser and mates with an opening on a sidewall of the housing. By this arrangement, the diffuser can be firmly secured to prevent displacement of the diffuser when the backlight module is shaken, and thus prevent the diffuser from colliding with other components and producing abnormal noises. Furthermore, the flexible positioning member is compression resistant and does not easily fail in a high temperature environment where various components of the backlight module expand. Hence, the backlight module of the present disclosure is highly reliable and is suitable to be applied in environments with large temperature variations and frequent vibrations, such as on vehicles.

Although the present disclosure has been described by way of the exemplary embodiments above, the present disclosure is not to be limited to those embodiments. Any person skilled in the art can make various changes and modifications without departing from the spirit and the scope of the present disclosure. Therefore, the protective scope of the present disclosure shall be the scope of the claims as attached.

What is claimed is:

1. A backlight module, comprising:
a housing comprising a backplate and a sidewall, the sidewall having an opening;
a diffuser disposed in the housing and comprising a main body and a protruding portion, wherein the protruding portion is disposed on a periphery of the main body and corresponds to the opening of the sidewall;
a light source disposed in the housing; and
a flexible positioning member sleeved onto the protruding portion of the diffuser and having a slot, the slot mating with an inner edge of the opening of the sidewall.

2. The backlight module of claim 1, wherein the flexible positioning member surrounds the protruding portion of the diffuser and has a hole, and the protruding portion is inserted into the hole.

3. The backlight module of claim 2, wherein the hole is perforated through the flexible positioning member.

4. The backlight module of claim 1, wherein the sidewall further has an indented portion, the indented portion is indented inward from an outer surface of the sidewall, and the opening is formed on the indented portion.

5. The backlight module of claim 4, wherein the outer surface of the sidewall defines a reference plane, and the opening of the sidewall and the flexible positioning member are located inside the reference plane.

6. The backlight module of claim 1, wherein the sidewall has a leading edge, the inner edge of the opening comprises a first section, the first section is connected to the leading edge of the sidewall and is substantially perpendicular to the leading edge of the sidewall, and the slot of the flexible positioning member mates with the first section.

7. The backlight module of claim 1, wherein the sidewall has a leading edge, the inner edge of the opening comprises a second section, the second section is located between the leading edge of the sidewall and the backplate and is substantially parallel to the leading edge of the sidewall, and the slot of the flexible positioning member mates with the second section.

8. The backlight module of claim 1, wherein the light source is disposed on the backplate, wherein the backlight module further comprises a supporting member, the supporting member is disposed on an inner side of the flexible positioning member and abuts the light source, the sidewall and the diffuser.

9. The backlight module of claim 8, wherein the supporting member has a supporting surface abutting the diffuser, wherein the flexible positioning member has a hole, the protruding portion of the diffuser is inserted into the hole, and a portion of an inner surface of the hole is aligned with the supporting surface of the supporting member.

10. The backlight module of claim 1, further comprising a frame, wherein the housing has an accommodating space, the frame extends to a side of the sidewall and the flexible positioning member away from the accommodating space, and the frame abuts an edge of the sidewall away from the backplate and an edge of the flexible positioning member away from the backplate.

11. An automotive display, comprising:
a display panel; and
a backlight module facing a rear surface of the display panel and comprising:
a housing comprising a backplate and a sidewall, the sidewall having an opening;
a diffuser disposed in the housing and comprising a main body and a protruding portion, wherein the protruding portion is disposed on a periphery of the main body and corresponds to the opening of the sidewall;
a light source disposed in the housing; and
a flexible positioning member sleeved onto the protruding portion of the diffuser and having a slot, the slot mating with an inner edge of the opening of the sidewall.

12. The automotive display of claim 11, wherein the flexible positioning member surrounds the protruding portion of the diffuser and has a hole, and the protruding portion is inserted into the hole.

13. The automotive display of claim 12, wherein the hole is perforated through the flexible positioning member.

14. The automotive display of claim 11, wherein the sidewall further has an indented portion, the indented portion is indented inward from an outer surface of the sidewall, and the opening is formed on the indented portion.

15. The automotive display of claim 14, wherein the outer surface of the sidewall defines a reference plane, and the opening of the sidewall and the flexible positioning member are located on inside the reference plane.

16. The automotive display of claim 11, wherein the sidewall has a leading edge, the inner edge of the opening comprises a first section, the first section is connected to the leading edge of the sidewall and is substantially perpendicular to the leading edge of the sidewall, and the slot of the flexible positioning member mates with the first section.

17. The automotive display of claim 11, wherein the sidewall has a leading edge, the inner edge of the opening comprises a second section, the second section is located between the leading edge of the sidewall and the backplate and is substantially parallel to the leading edge of the sidewall, and the slot of the flexible positioning member mates with the second section.

18. The automotive display of claim 11, wherein the light source is disposed on the backplate, wherein the backlight module further comprises a supporting member, the supporting member is disposed on an inner side of the flexible positioning member and abuts the light source, the sidewall and the diffuser.

19. The automotive display of claim 18, wherein the supporting member has a supporting surface abutting the diffuser, wherein the flexible positioning member has a hole, the protruding portion of the diffuser is inserted into the hole, and a portion of an inner surface of the hole is aligned with the supporting surface of the supporting member.

20. The automotive display of claim 11, wherein the backlight module further comprises a frame, wherein the housing has an accommodating space, the frame extends to a side of the sidewall and the flexible positioning member away from the accommodating space, and the frame abuts an edge of the sidewall away from the backplate and an edge of the flexible positioning member away from the backplate.
